(19) United States
(12) Patent Application Publication
(10) Pub. No.: US 2020/0108349 A1
(43) Pub. Date: Apr. 9, 2020

(54) POINT OF ENTRY WATER PURIFICATION SYSTEMS AND METHODS

(71) Applicant: BGM Water, LLC, Punta Gorda, FL (US)

(72) Inventor: Tom Cartwright, Punta Gorda, FL (US)

(73) Assignee: BGM Water, LLC, Punta Gorda, FL (US)

(21) Appl. No.: 16/595,589

(22) Filed: Oct. 8, 2019

Related U.S. Application Data
(60) Provisional application No. 62/743,250, filed on Oct. 9, 2018.

(51) Int. Cl. B01D 61/12; C02F 1/44; C02F 9/00; B01D 61/02; B01D 61/08; B01D 61/04

(52) U.S. Cl. CPC B01D 61/12; C02F 1/441; C02F 9/00; C02F 2001/007; B01D 61/08; B01D 61/04; B01D 61/025

(57) ABSTRACT

Apparatus and systems for point of entry water purification using reverse osmosis are provided. Generally, systems include a storage tank for containing purified water, wherein elements of the purification system are attached directly to the storage tank, at its exterior or interior. At the storage tank exterior surface, a mounting plate is attached that contains a sediment filter and a reverse osmosis element. The storage tank interior space contains a mechanical float valve system that uses the amount of purified water within the storage tank to provide a negative feedback system to proportionally control flow of water into the purification system.

### FIELD

Inventive concepts provide water purification apparatus and systems. More specifically, inventive concepts provide apparatus and systems for “point of entry,” or whole-house residential or light industrial reverse osmosis.

### BACKGROUND

Reverse osmosis (RO) has been used for decades to purify water for various applications. Generally, RO systems are used to purify water by removing dissolved impurities and particles larger than about 7.0 angstrom (0.0007 micron).

Generally speaking, osmosis occurs naturally, when a diluted solution diffuses through a semipermeable membrane into a more concentrated solution until equilibrium is reached. In RO, pressure is exerted on the side with the concentrated solution to force the water molecules across the membrane to the lower concentration side. The applied pressure must be sufficient to overcome osmosis. This reversed flow produces purified water from the concentrated solution, since the semipermeable membrane does not permit dissolved impurities and particles to pass through it.

A typical RO filtering system uses a semi-permeable membrane that has the ability to remove and reject a wide spectrum of impurities and contaminants from water. A predetermined pressure is applied to the incoming water to force the incoming water through the membrane. The membrane filters impurities from the incoming water, leaving purified water on the other side of the membrane (commonly referred to as the “permeate” stream). The impurities left on the membrane are washed away by a portion of the incoming water than does not pass through the membrane. The water carrying the impurities washed away from the membrane is commonly referred to as the “concentrate” stream.

RO systems can vary depending upon brand and design, but in general, these systems perform the following functions: pre-filtration, reverse osmosis, drainage of concentrate and storage of permeate. In turn, typical components of RO systems include semipermeable membranes, prefilters, carbon filters, storage tanks, as well as valves and flow meters to control flow of fluid through the system.

Point of Entry (also known as Whole House) RO systems have been available in the U.S. market since the 1980s. However, these systems were typically commercial RO systems installed in homes. As a result, they were large, cumbersome, hard to service and very expensive.

In the early 2000s, more economical and compact whole house RO systems were introduced to the market. These systems offer several advantages over water softeners/filters. Whole house RO systems do not require salt or any other additional chemicals. Where a water softener simply replaces one ion with another (adding sodium or potassium to the household water in place of calcium), a whole house RO system removes approximately 98% of total dissolved solids (TDS) in the water, providing “bottled quality” water throughout the entire home. In addition, because whole house RO systems do not add any chemicals to the water, they are the most environmentally friendly form of water purification.

Even though improvements to whole house RO systems have been made, disadvantages remain. For example, the required equipment can become too large to easily fit in a garage or basement. Current whole house RO systems require space for a storage tank (generally 31 inches to 36 inches in diameter), plus floor space for the RO system, meters, valves and filters (generally 24×24 inches). Additionally, electrical (wiring) and fluid (tubes) connections required to connect all of the components in an operable manner can create a complex system that presents challenges for maintenance.

### SUMMARY

Inventive concepts relate to apparatus and systems for purifying water by reverse osmosis. In some aspects, inventive devices, systems and methods can be used to provide point of entry water purification using reverse osmosis for residential or light industrial applications.

Generally speaking, inventive water purification systems provide a unitary device that reduces the number and complexity of componentry. Components of the water purification system are directly mounted onto the exterior surface or interior space of the water storage tank, providing a streamlined, integrated system. In this way, the footprint of the device is substantially reduced, and maintenance of the system is simplified. Components are mounted at convenient, easy to access locations on the storage tank, making servicing of the system much easier.

In addition, electrical components required in previous water purification systems are eliminated, and replaced with mechanical valves to control water flow into the system. By eliminating some of the electrical components (e.g., solenoid valve), inventive systems provide a more robust system that can be more easily installed and maintained by plumbing professionals. Overall material costs for the water purification systems are reduced.

Inventive water purification systems eliminate much of the tubing and wiring connections between the RO system and permeate storage tank. As a result, the water purification systems can provide a streamlined, attractive “appliance look” that reduces the possibility of wires or hoses becoming accidentally disconnected.

Additional features of the design relate to improved efficiency. In many applications, inventive water purification systems can operate on the standing incoming water pressure without requiring a booster pump to increase the pressure of unpurified water coming into the system. In some aspects, water purification systems can operate effectively at incoming pressures as low as 40 psi. Further, inventive systems are designed to operate at 50% recovery or better, a superior water purification efficiency.

In still further aspects, due to the system design and membrane element configuration, inventive systems can handle incoming hardness levels of up to 30 grains (513 mg/L), thus eliminating the need for additional pretreatment, such as a water softener.

Additionally, wherein other whole home RO systems average 98% TDS rejection, inventive water purification systems described herein can provide on average only about 95% TDS rejection, or an average in the range of about 90% to 97% TDS rejection, or in a range of about 92% to about 96% TDS rejection. By providing a high recovery (e.g., 50% recovery or higher) and a lower TDS rejection than other systems, inventive water purification systems can provide additional advantages. In these aspects, the increase in salt passage into the permeate stream can significantly reduce the possibility that permeate water may become aggressive and have an adverse effect on downstream plumbing and appliances. This is also a significant improvement over commercially available water purification systems.

In some implementations, water purification systems comprise:

(a) a sediment filter for receiving unpurified water;

(b) a reverse osmosis element fluidically connected to the sediment filter, the reverse osmosis element containing a semipermeable membrane for producing a purified water stream and a concentrate water stream;

(c) a product line in fluid communication with the reverse osmosis element, the product line configured to transport purified water from the reverse osmosis element;

(d) a drain line connected to the reverse osmosis element, the drain line being configured to transport the concentrate from the reverse osmosis element;

(e) a storage tank having an exterior surface and an interior space, the interior space configured to receive and store purified water from the product line; and

(f) a mechanical float valve system contained within the storage tank, wherein the mechanical float valve system comprises an inlet valve to control the flow of unpurified water into the sediment filter, and

(g) a mounting plate attached to the exterior surface of the storage tank, the mounting plate containing the sediment filter and the reverse osmosis element.

In further aspects, a unitary water purification system is provided that comprises a storage tank having an exterior surface and an interior space,

the exterior surface of the storage tank bearing a mounting plate, the mounting plate containing a sediment filter and a reverse osmosis element fluidically connected to the sediment filter,

the storage tank interior space containing a mechanical float valve system that comprises an inlet float valve to control flow of unpurified water into the sediment filter,

wherein the storage tank interior space is configured to receive and store a predetermined amount of purified water from the reverse osmosis element, and wherein the mechanical float valve system uses the amount of purified water within the storage tank to provide a negative feedback system to proportionally control flow of water into the sediment filter.

Optional features include one or more of the following: a reclaim system to further improve operating efficiency, an automatic bypass system, and high recovery options that reduce the amount of water going to drain.

Applications of inventive concepts will be readily appreciated in the field of reverse osmosis systems for residential and light industrial use.

Aspects of the invention will now be described in more detail.

### BRIEF DESCRIPTION OF THE FIGURES

The disclosure may be more completely understood in consideration of the accompanying drawings, in which:

FIG. 1 is a schematic diagram of a water purification system in accordance with an embodiment of the invention, from a front view;

FIG. 2 is a schematic diagram of a float valve system in accordance with inventive concepts;

FIG. 3 is a schematic diagram of a side view of the embodiment shown in FIG. 1.

The figures are not necessarily to scale. Like numbers in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration of several specific embodiments. It is to be understood that other embodiments are contemplated and may be made without departing from the scope or spirit of the present disclosure. The following detailed description, therefore, is not to be taken in a limiting sense.

Generally, when referring the apparatus and systems herein, reference will be made to point of entry water purification systems. Residential and light industrial applications of the water purification systems will be utilized to describe inventive concepts, as these applications are useful to highlight features and advantages. However, it will be understood upon review of the present specification that inventive water purification systems can be adapted for additional uses outside residential and light industrial applications.

In some aspects, inventive concepts provide water purification systems that include key components physically mounted to the water storage tank, thereby reducing the overall footprint of the water purification system. The entire water purification system can fit within the footprint of the storage tank 4, requiring no additional floor space for components. In additional aspects, inventive concepts provide water purification systems that reduce or eliminate the number of electrical components in the system, thereby providing a more robust and easily maintained system. In these aspects, electrical valve systems commonly used in water purification systems are replaced with mechanical valve systems that can be conveniently contained within the system itself, contributing to the overall streamlined nature of the system. In still further aspects, inventive water purification systems can reduce the number of required components, while providing enhanced performance of the water purification system.

These and other features of the water purification systems will now be described.

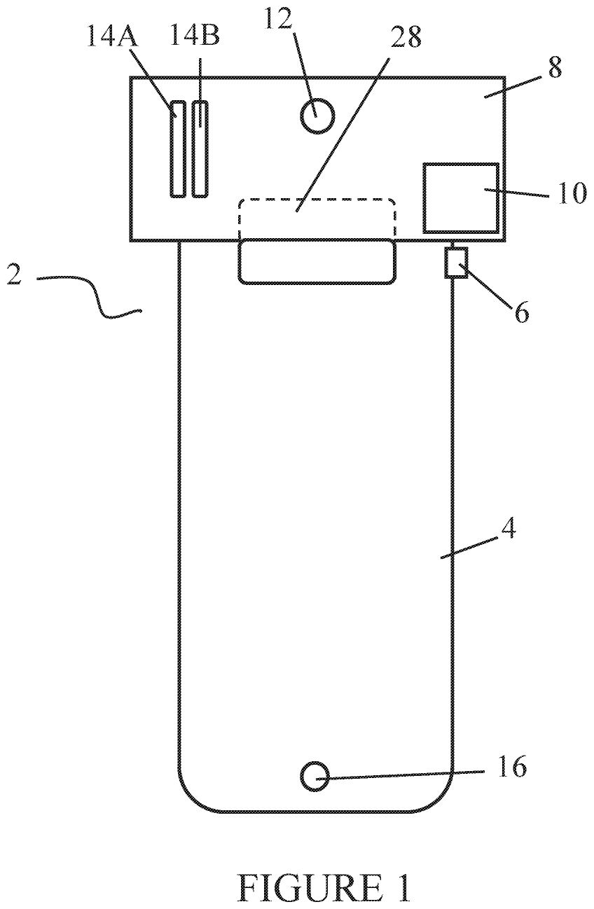

Referring to FIG. 1, a water purification system 2 is shown which generally includes a storage tank 4, system feed 6, mounting plate 8 and outlet valve 16. Storage tank 4 can be any suitable atmospheric storage tank for use with home or light industrial water purification systems. Storage tank size can be selected depending upon space and customer usage requirements. For point of entry (whole house or light industrial use), illustrative storage tanks 4 can be sized to provide storage of 100 to 300 gallons, for example 200 gallons. In some aspects, inventive water purification systems 2 can be used in homes and light industrial applications that require up to about 700 gallons of water per day, or up to about 1400 gallons of water per day. It is to be understood a wide range of storage tank sizes can be used in connection with inventive concepts.

In some aspects, inventive concepts provide a water purification system that does not include the storage tank 4, but rather includes the remaining components of the system 2 described herein, provided as a modular unit. In these aspects, the components of water purification system 2 can be adapted to be installed onto and into an existing atmospheric storage tank. Thus, inventive systems can retrofit an existing water purification system that is already installed within a home or commercial property to provide the advantages described herein.

System feed 6 can be connected to a water supply (not shown) which may be a well, municipal water supply, or other water supply as may be familiar to one of skill in the art.

Optional upstream components that can be used with inventive water purification systems 2 include, for example, a prefilter system (not shown) and/or a booster pump. When included, prefilter systems can reduce or eliminate unwanted materials found in unpurified water such as larger particulates, heavy transition metals, chlorine, chloramines, volatile organic compounds, and sediments from the feedwater. Suitable prefilters include carbon filters, KDF filters, and the like. When the prefilter system utilizes more than one type of filter, the multiple components can be provided in series, if desired. In some aspects, combinations of prefilters may be used to target particular contaminants. Illustrative carbon filters can include activated carbon and serve to remove ions such as chloride from the feedwater. Suitable KDF filters may comprise carbon zinc alloy. Although not required, in some aspects, utilization of a prefilter system may extend the life of RO elements of the water purification system 2.

In accordance with inventive principles, water purification systems 2 can operate on line pressure, thereby avoiding the extra expense and required footprint for a booster pump.

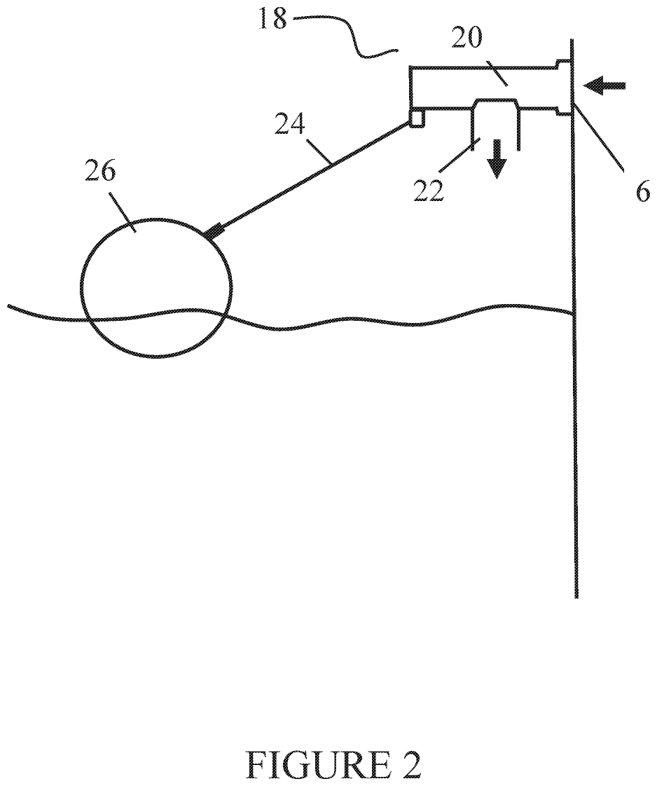

Feedwater passes through system feed 6 into a float valve system 18 that is located within the interior space of storage tank 4. Referring to FIG. 2, feedwater enters through system feed 6 and into float valve system 18. Direction of water flow through the float valve system 18 is illustrated with arrows. As illustrated in FIG. 2, float valve system 18 generally includes float valve 20, valve outlet 22, float valve stem 24 that extends toward the interior of the storage tank 4 connects the float valve 20 to a float device 26. The float device 26 is typically round and filled with air. This device is air tight and is attached to the valve stem 24. Due to the trapped air in the float device, it has buoyancy and will float atop the water within storage tank 4. Suitable float valve systems are commercially available, for example the R400 Series BOB® float valve from Control Devices, LLC, Fenton, Mo. It will be readily appreciated that similar mechanical float valves can be substituted, given the teaching herein.

The interior of storage tank 4 maintains permeate that has passed through the water purification system and is ready for use and consumption by the end user (e.g., homeowner). Typical atmospheric storage tanks have a capacity of about 100 to about 300 gallons, with some models providing a capacity of 200 gallons. Incoming water from a feedline passes through the float valve 20, then into the filter apparatus of water purification system.

The float valve system 18 utilizes the water level within storage tank 4 to control water inflow into the water purification system 2. The float valve system 18 is positioned at the system feed 6; thus, when the float valve 20 is closed, water will not enter into water purification system through system feed 6. Float valve 20 is opened and closed by the float valve stem 24, which contains the float 26 at its end. In use, so long as the float device 26 is in the “down” position, float valve 20 will remain open and allow water to pass into the sediment filter 10 to begin the purification process.

As the storage tank 4 fills with water (permeate), eventually it will reach the mechanical float device 26. Once the float device 26 rises to a preset level, it forces the float stem 24 to move the plunger within the float valve 20, thereby closing the float valve 20 and shutting off the water flow into sediment filter 10. In this manner, the system is shut down and overflow of the storage tank 4 is prevented.

Likewise, as the permeate stored within the storage tank 4 is consumed, the water level within the storage tank 4 drops. Correspondingly, the float device 26 drops with the water level. Once the float device 26 drops below a preset level, the float valve stem 24 will move the plunger within the float valve, thereby causing float valve 20 to open. The float valve 20 will remain open until the float device 26 is raised back to the predetermined level by the rising water. The float valve 20 will then be closed and the water supply to the water purification system 2 shut off.

The float valve system 18 thus provides a negative feedback system to proportionally control flow of water into the purification system.

In accordance with inventive concepts, use of the mechanical float valve system 18 can provide significant advantages. Because the mechanical float valve system 18 is not electrically controlled, all previous wiring connections are eliminated, and servicing of the system has been made significantly easier. Solenoid valves, which are commonly used to control water inflow into water purification systems, are eliminated. Those skilled in plumbing arts readily appreciate this simplified, mechanical system.

Referring back to FIG. 1, a mounting plate 8 is attached to the exterior surface of storage tank 4. Mounting plate 8 can be fabricated from any suitable material, for example, a corrosion-resistant material such as stainless steel, aluminum or plastic. In accordance with inventive aspects, mounting plate 8 provides a substrate for attaching components of the water purification system 2 to the exterior of storage tank 4. Advantageously, mounting plate 8 can be provided with dimensions that maintain the components of the water purification system 2 in close proximity, but spaced from, storage tank 4. In this way, components of the water purification system 2 are easily accessible for maintenance and/or replacement, yet do not take up unnecessary space at the installation site.

Mounting plate 8 includes an outward face and inward face. As shown, a number of system components are mounted on the mounting plate 8. From the front view of the water purification system 2, the outward face of mounting plate 8 includes a sediment filter 10, pressure gauge 12, and flow meters 14A and 14B. The inward face of mounting plate 8 includes one or more reverse osmosis elements 28, which are partially visible from the front view, as shown in FIG. 1.

Sediment filter 10 can be used to remove extra fine particulate such as sand, dirt, silt or rust. Illustrative sediment filters include polypropylene filters; however, inventive systems can utilize any suitable sediment filter. After passing through sediment filter 10, water passes through pressure gauge 12. Pressure gauge 12 can serve to monitor pressure within the system, and also to calibrate water purification system 2.

After passing through pressure gauge 12, water then enters reverse osmosis element 28, which is mounted on the inner face of mounting plate 8. RO element 28 can include multiple RO semipermeable membranes. Flow through RO semipermeable membrane(s) produces concentrate and permeate, each of which passes through a dedicated flow meter via a separate fluid path. Permeate passes through flow meter 14A, through permeate outlet line 30 and through storage tank inlet 32, to the interior space of storage tank 4. Concentrate, in turn, passes through flow meter 14B, then to a valve to regulate the amount of water going to drain, then to an appropriate drain line.

A wide variety of RO semipermeable membranes can be utilized in connection with inventive water purification systems. Suitable reverse osmosis elements 28 can be obtained commercially from ENVI Solutions, Punta Gorda, Fla. An additional illustrative RO semipermeable membrane is the Merlin® Reverse Osmosis Membrane Element, which is commercially available via the Internet. Other RO semipermeable membranes can be easily substituted as desired.

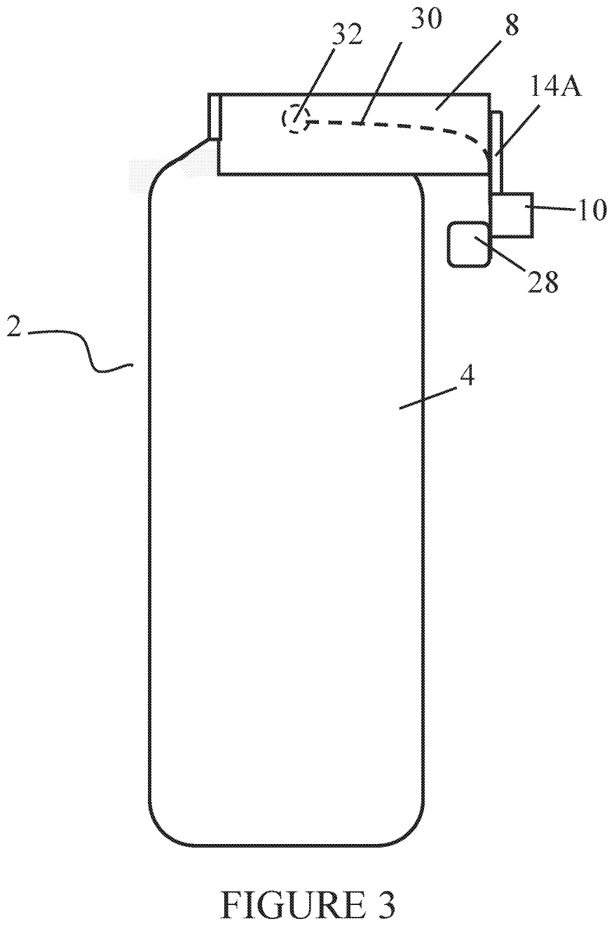

A concentrate outlet line directs concentrate from the RO element(s) 28, through flow meter 14B, and ultimately to a drain valve. As illustrated in FIG. 3, permeate passes through flow meter 14A, through permeate outlet line 30, then to tank inlet 32, and into the interior of storage tank 4 where it is retained until used by the consumer. FIG. 3 shows a side view of water purification system 2 and illustrates the arrangement of sediment filter 10, flow meter 14A (flow meter 14B being obstructed in this view), and reverse osmosis element 28, mounted on mounting plate 8. In the particular embodiment illustrated, tank inlet 32 is located at a position near the top on the side of the tank 4. It will be understood that tank inlet 32 can be located at any position near the top of tank 4, and on any desired side, so long as tank inlet 32 is above the float valve assembly 18.

Permeate collected and stored within storage tank 4 is thus ready for use by the end user.

Together, the sediment filter and RO element remove a plurality of contaminants from water, such as those illustrated in Table 1:

TABLE 1
Illustrative Contaminants Removed with Water Purification System

| | |
|---|---|
| Arsenic V | Silica |
| Cadmium | Chlorine |
| Chloramines | Copper |
| Fluoride | Hardness Ions |
| Lead | Nitrates |
| Pharmaceuticals | Sediment |
| TDS | Bacteria |

As illustrated in FIG. 1, inventive water purification systems 2 provide an integrated, “appliance-like” appearance that minimizes exterior wiring and lines and maximizes accessibility of components. This provides efficient manufacturing as well as a small footprint design. The resulting water purification system can free up previously required floor space within a user's home, eliminate loose wire and tubing, reduce material costs, and improve the overall aesthetics of the system. Moreover, the accessibility of all components can make servicing of the system easier, since components are at eye level and/or within easy reach of a technician. In accordance with inventive aspects, water purification systems can require an average of two (2) square feet less of floor space within the consumer's home. This can be a significant advantage, which can allow water purification systems to be installed in a variety of places within a home, and in smaller spaces. In some aspects, the water purification system 2 is the only unit between the feedwater and the permeate feedline into the home.

As shown, water purification system 2 has a system feed 6 which is connectable to a feedwater line. System feed 6 is configured to receive feedwater (unpurified water), which is typically at standard residential line pressure (generally between 45 to 70 psi). The feedwater enters water purification system 2 through system feed 6 and into float valve 18.

Surprisingly, water purification systems in accordance with inventive concepts can operate on the standing incoming water pressure without requiring a booster pump to increase the pressure. Typical commercially available reverse osmosis systems require a booster pump as they need to operate at a minimum of 80 psi. In contrast, inventive water purification systems can be capable of operating effectively at pressures as low as 50 psi, or as low as 45 psi, or even as low as 40 psi. In some implementations, the system can be used with an incoming water pressure in a range of about 40 psi to about 90 psi, a significant improvement over prior systems.

In accordance with inventive principles, water purification system 2 is a residential reverse osmosis filtration system capable of providing a sufficient, constant flow of filtered water without requiring a booster pump. However, certain features of inventive systems are also usable with a repressurization pump. Repressurization pumps can raise the pressure of the permeate stream after it has passed through the water purification system.

As illustrated in FIG. 1, tank 4 includes system outlet valve 16, located at the bottom of the tank. System outlet valve 16 controls release of permeate from the tank 4 to the consumer for use. Any suitable valve can be used for system outlet valve 16. One illustrative valve is a ball valve. System outlet valve 16 can be sized according to the supply line feeding the end user (e.g., residential water supply line, or in the case of a light industrial application, the supply line for the business). Purified water contained within storage tank 4 is released through system outlet valve 16 and connects to the home with a repressurization pump for end use.

Water purification systems in accordance with inventive concepts can provide a number of features. For example, water purification systems can provide an average TDS rejection rate in a range of about 90% to about 97% or about 92% to about 96%; an average permeate flow of about 700 gallons per day (GPD); and permeate storage in a range of about 100 to about 300 gallons. In some aspects, inventive water purification systems can provide an average system recovery in a range of about 33% to about 50%, in some cases about 50%. In other words, when operating at 50% recovery, for every gallon of water that goes to drain 1 gallon of water goes into permeate storage tank 4.

In some aspects, inventive water purification systems can treat water with a hardness up to about 30 grains (513 mg/L as calcium carbonate, CaCO₃), iron content up to about 0.3 mg/L, and manganese up to about 0.1 mg/L. Thus, in some aspects, inventive water purification systems can operate without the need for a water softener, which can be a significant improvement.

Optional components include any one or more of the following. An ozone generator can be included to maintain sterility of the permeate contained within tank 4 interior space. A booster pump can be utilized to increase the pressure of incoming water into the system feed 6. As an additional feature, systems that include a booster pump can also include additional valving systems to allow the water purification system 2 to operate with a much small amount of water going to drain.

One optional component comprises a reclaim system. In these aspects, concentrate exiting the water purification system is fed into a separate reclaim storage tank. In turn, the reclaim storage tank can be connected with an end user's sprinkler line. With this reclaim system, the water purification system can operate at 100% water efficiency. This can be particularly desirable in arid climates where water supply can be an issue.

In some implementations, reclaim storage tank can be configured in a similar manner to storage tank 4 illustrated in the figures, including an inlet in the top area of the tank (similar to tank inlet 32), an outlet valve near the bottom of the tank (similar to outlet 16). Optionally, reclaim storage tank can include a float valve system (similar to float valve system 18 previously described), for controlling flow of concentrate into reclaim storage tank. Other optional features include an overflow system to allow overflow to pass to the drainage system, and/or a pump for providing additional pressure to a sprinkler system. Reclaim system can be used for sprinkler or irrigation systems, or other water systems at the point of use that do not require purified water.

Another optional feature of inventive systems is an automatic bypass system. In these aspects, a bypass system can be activated if the permeate level within storage tank 4 drops below a predetermined level. The bypass system can be positioned at any convenient location upstream of the water purification system. As discussed herein, a carbon filter is an optional component upstream of the water purification system. In some aspects, the bypass system can be positioned downstream of the carbon filter. In this manner, carbon filtered water can be provided to the end user until the storage tank 4 refills with permeate. Accordingly, water that has been filtered through a carbon filter (but has not yet been purified by the water purification system 2 described herein) can be provided to the end user for an intermediate period of time. Alternatively, the bypass system can be positioned such that untreated feedwater is provided to the end user. This can be the case whether a carbon filter is present (in which case, the bypass would be positioned upstream of the carbon filter), or when a carbon filter is not used. In any event, the bypass system can provide water to an end user for an intermediate period until the storage tank can refill.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained.

In the specification and in the claims, the terms “including” and “comprising” are open-ended terms and should be interpreted to mean “including, but not limited to . . . .” These terms are broader than, and therefore encompass, the more restrictive terms “consistently essentially of” and “consisting of.”

As used herein and in the appended claims, the singular forms “a,” “an,” and “the” include plural reference unless the context clearly dictates otherwise. As such, the terms “a” (or “an”), “one or more” and “at least one” can be used interchangeably herein.

1. A water purification system comprising:
(a) a sediment filter for receiving unpurified water;
(b) a reverse osmosis element fluidically connected to the sediment filter, the reverse osmosis element containing a semipermeable membrane for producing a purified water stream and a concentrate water stream;
(c) a product line in fluid communication with the reverse osmosis element, the product line configured to transport the purified water stream from the reverse osmosis element;
(d) a drain line connected to the reverse osmosis element, the drain line being configured to transport the concentrate water stream from the reverse osmosis element;
(e) a storage tank having an exterior surface and an interior space, the interior space configured to receive and store purified water from the product line; and
(f) a mechanical float valve system contained within the storage tank, wherein the mechanical float valve system comprises an inlet valve to control the flow of unpurified water into the sediment filter, and
(g) a mounting plate attached to the exterior surface of the storage tank, the mounting plate containing the sediment filter and the reverse osmosis element.

2. The system of claim 1 wherein the mechanical float comprises a float valve system.

3. The system of claim 1 further comprising a prefilter in fluid communication with, and upstream of the inlet valve.

4. The system of claim 3 wherein the prefilter includes solid carbon media for suspending impurities from the unpurified water.

5. The system of claim 1 further comprising an ozone generator mounted to the exterior surface of the storage tank.

6. The system of claim 1 further comprising a repressurization pump fluidically connected to an outlet line from the storage tank.

7. The system of claim 1 further comprising a second storage tank fluidically connected to the drain line, the second storage tank configured to contain the concentrate.

8. The system of claim 7 wherein the second storage tank is fluidically connected with a sprinkler system.

9. The system of claim 3 further comprising an automatic bypass system connected downstream of the prefilter, the automatic bypass system comprising a line for providing prefiltered water directly out of the system and to an end user.

10. The system of claim 1 further comprising an automatic bypass system connected upstream of the inlet valve, the automatic bypass system comprising a line for providing unpurified water directly to an end user.

11. The system of claim 1 further comprising a booster pump fluidically connected upstream of the sediment filter.

12. The system of claim 1 wherein the inlet valve is located at a system feed, and the system feed delivers unpurified water to the inlet valve at a pressure of 70 psi or less.

13. The system of claim 1 wherein the inlet valve is located at a system feed that delivers unpurified water from a source at home water pressure conditions.

14. The system of claim 1 wherein the system can provide an average system recovery in a range of about 33% to about 50%.

15. A unitary water purification system comprising a storage tank having an exterior surface and an interior space,
the exterior surface of the storage tank bearing a mounting plate, the mounting plate containing a sediment filter and a reverse osmosis element fluidically connected to the sediment filter,
the storage tank interior space containing a mechanical float valve system that comprises an inlet float valve to control flow of unpurified water into the sediment filter,
wherein the storage tank interior space is configured to receive and store a predetermined amount of purified water from the reverse osmosis element, and wherein the mechanical float valve system uses the amount of purified water within the storage tank to provide a negative feedback system to proportionally control flow of water into the sediment filter.

16. The system of claim 15 further comprising a prefilter in fluid communication with, and upstream of the inlet float valve.

17. The system of claim 16 wherein the prefilter includes solid carbon media for suspending impurities from the unpurified water.

18. The system of claim 15 further comprising an ozone generator mounted to the exterior surface of the storage tank.

19. The system of claim 15 further comprising a repressurization pump fluidically connected to an outlet line from the storage tank.

20. The system of claim 15 further comprising a second storage tank fluidically connected to a drain line from the reverse osmosis element, the second storage tank configured to contain the concentrate.

21. The system of claim 20 wherein the second storage tank is fluidically connected with a sprinkler system.

22. The system of claim 16 further comprising an automatic bypass system connected downstream of the prefilter, the automatic bypass system comprising a line for providing prefiltered water directly out of the system and to an end user.

23. The system of claim 16 further comprising an automatic bypass system connected upstream of the inlet valve, the automatic bypass system comprising a line for providing unpurified water directly to an end user.

24. The system of claim 16 further comprising a booster pump fluidically connected upstream of the sediment filter.

25. The system of claim 16 wherein the inlet float valve is located at a system feed, and the system feed delivers unpurified water to the inlet float valve at a pressure of 70 psi or less.

26. The system of claim 16 wherein the inlet float valve is located at a system feed that delivers unpurified water from a source at home water pressure conditions.

27. The system of claim 16 wherein the system can provide an average system recovery in a range of about 33% to about 50%.
